(19) United States
(12) Patent Application Publication
(10) Pub. No.: US 2024/0076003 A1
(43) Pub. Date: Mar. 7, 2024

(54) WHEEL FOR A BICYCLE AND BICYCLE EQUIPPED THEREWITH

(71) Applicant: THE CHILLAFISH COMPANY, naamloze vennootschap, Antwerpen (BE)

(72) Inventor: Sebastian De Roeck, West-Malle (BE)

(73) Assignee: THE CHILLAFISH COMPANY, naamloze vennootschap, Antwerpen (BE)

(21) Appl. No.: 18/280,342

(22) PCT Filed: Feb. 28, 2022
(86) PCT No.: PCT/IB2022/051731

§ 371 Date: Sep. 5, 2023

(30) Foreign Application Priority Data
Mar. 8, 2021 (BE) 2021/5172

(51) Int. Cl. B62J 6/12; B60B 1/00; B60B 27/00; B60B 27/02; B62J 6/26

(52) U.S. Cl. CPC B62J 6/12; B60B 1/003; B60B 27/0047; B60B 27/023; B62J 6/26

(57) ABSTRACT

Wheel for a bicycle, particularly a balance bicycle, the wheel is provided with integrated lighting and an integrated electromagnetic power source which provides the lighting with power as soon as the wheel is driven when riding the bicycle.

### CROSS-REFERENCE TO RELATED APPLICATIONS

The present application is the National Phase entry of International Patent Application No. PCT/IB2022/051731 filed Feb. 28, 2022, which claims priority to Belgium Patent Application No. 2021/5172 filed Mar. 8, 2021, the entire contents of both are hereby incorporated by reference into this application.

### TECHNICAL FIELD

The present disclosure relates to a wheel of a bicycle, particularly of a balance bicycle, but is not restricted to this.

### BACKGROUND

Children enjoy having things which are provided with lighting, such as for example shoes with lights in the soles which light up when walking or a lit skateboard or the like.

The purpose of the present disclosure is to provide a possibility for simply and protectedly incorporating lighting in a wheel, whereby the lighting is activated by the rotating wheel when riding.

### SUMMARY

To this end, the present disclosure relates to a wheel for a bicycle that is provided with integrated lighting and an integrated electromagnetic power source which provides power to the lighting as soon as the wheel is driven when riding the bicycle.

In some embodiments, the wheel is provided with a hollow wheel hub and the power source is incorporated therein and thus protected from damage and the effects of weather conditions.

Practically, the power source is composed of a stator and a rotor co-axially therewith, whereby in mounted condition the rotor is connected to the wheel hub such that the rotor rotates with the wheel and the stator is freely rotatable relative to the rotor.

The rotor can then be a bearer of one or more contacts to which the LED lights are connected for their power supply and which protrude radially outwardly through passages in the wheel hub for example.

By rigidly connecting the LED lights to the rotor, the rotor, together with the LED lights, forms one assembly as it were that can be manipulated in one piece, for example for an easy assembly and disassembly in and out of the wheel.

Therefore, in this case it is useful that the passages for the LED lights are formed by a groove which extends from an open end of the hub substantially in an axial direction.

Consequently, the rotor, together with the LED lights, can be axially slid from said open end into the hub.

In particular the present disclosure relates to a wheel for a bicycle, particularly a balance bicycle, said wheel being provided with a hollow wheel hub with a bearing therein and one or more lit spokes with a recess and one or more LED lights which extend at least partially in said recess and provided with an integrated electromagnetic power source which provides power to the LED lights as soon as the wheel is driven when riding the bicycle, wherein the hollow wheel hub is formed by a casing with an open end and a base and the power source is applied between the base and the bearing, the casing of the wheel hub is provided with one or more grooves which extend from the open end of the wheel hub substantially in an axial direction and form a passage along which the LED lights are connected to the power source and in that the bearing is mounted in the wheel hub by a mounting ring which along its outer contour is provided with one or more protrusions with which the mounting ring can be axially slid and secured in the one or more aforementioned grooves and that the recesses in the lit spokes are covered by a transparent or translucid cover on either side of the wheel. Such integrated lighting is easy to mount in the wheel, whereby the lighting is fully protected in the wheel.

The present disclosure also relates to a bicycle equipped with a wheel according to the present disclosure as specified, whereby the wheel is non-rotatably mounted in the front fork or in the frame of the bicycle and around which the stator of the power source is non-rotatably mounted.

In particular the present disclosure relates to a balance bicycle.

### BRIEF DESCRIPTION OF THE DRAWINGS

With the intention of better showing the characteristics of the present disclosure, an embodiment of a wheel according to the present disclosure is described hereinafter, by way of an example without any limiting nature, with reference to the accompanying drawings wherein:

FIG. 1 schematically shows a perspective view of a balance bicycle with a wheel according to the present disclosure;

FIG. 2 shows the wheel indicated with F2 on a larger scale in FIG. 1;

FIG. 3 shows the section indicated with frame F3 in FIG. 2 on a larger scale, but mounted with a cover;

FIG. 4 shows the section of FIG. 3 but without the bearing of the wheel;

FIG. 5 shows an exploded view of the wheel of FIG. 2.

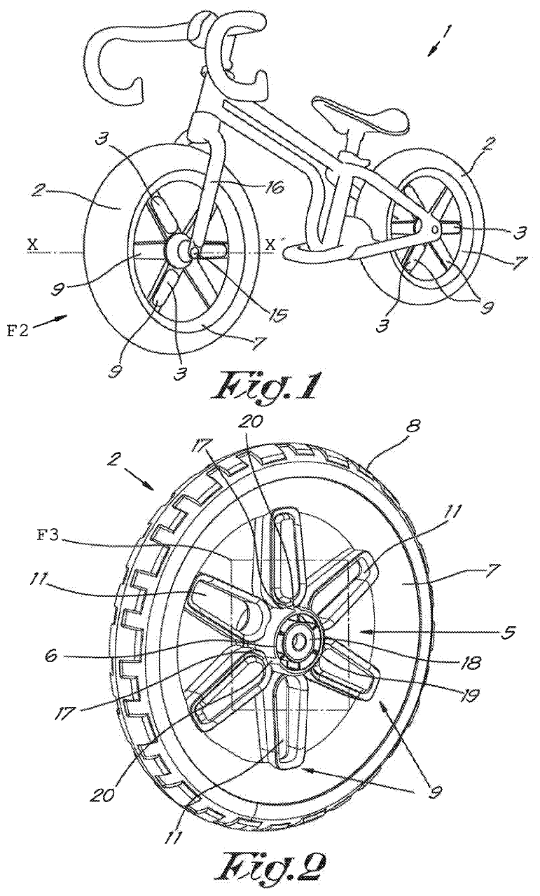

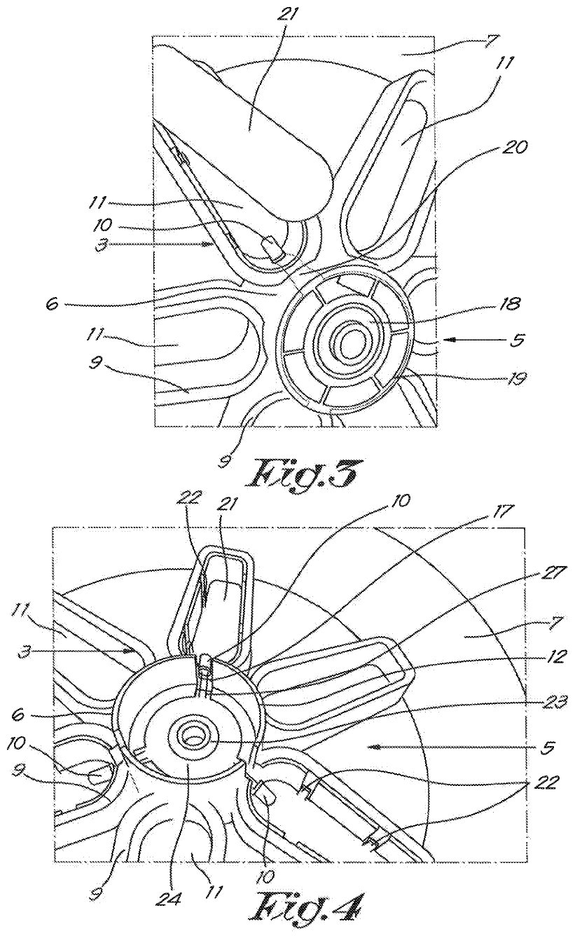

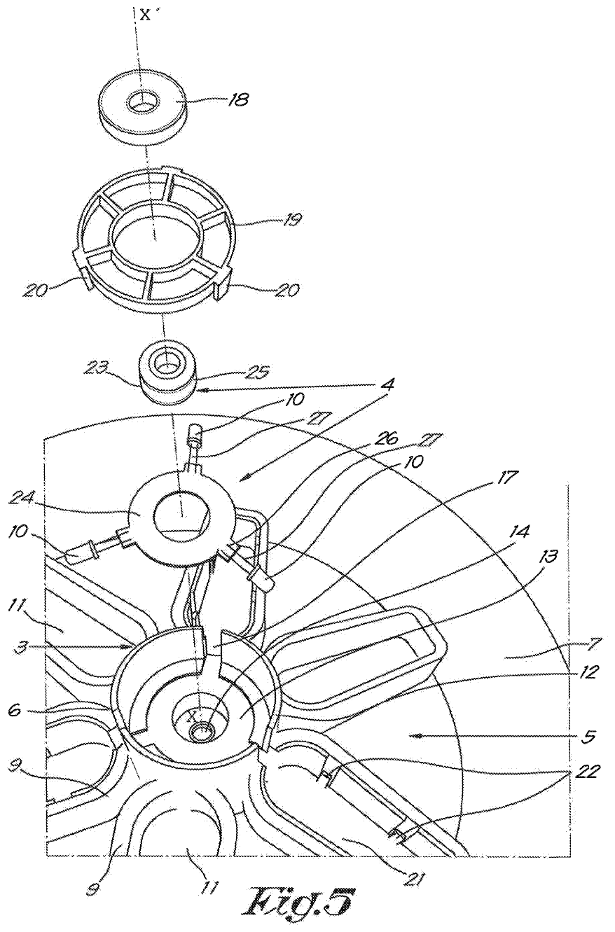

### DETAILED DESCRIPTION

The balance bicycle 1 for children shown in FIG. 1 is provided with at least one wheel 2 according to the present disclosure with integrated lighting 3 and an integrated electromagnetic power source 4.

In this case the balance bicycle 1 is equipped with such front wheel 2 with lighting 3, but this could also be the back wheel or both wheels.

As is known, such wheel 2 contains a hollow wheel hub 5 formed by a cylindrical casing 6 and a rim 7 with a tyre 8 which is connected with the wheel hub 5 by radial spokes 9, in this case six substantially elongated O-shaped or oval-shaped spokes 9 which delimit an open recess 11 in the spokes 9. In the example, three of the six spokes 9 are lit, each by a LED light 10.

The wheel 2 is for example manufactured by injection moulding or the like from a synthetic material.

The wheel hub 5 is open at one axial end 12 and at the other end is provided with a base 13 with a passage 14 for the wheel axle 15 with which the wheel 2 is mounted in the front fork 16.

On the level of the foot of each of the three lit spokes the casing 6 of the wheel hub 5 is provided with a groove 17 which extends axially from the open end 12 of the wheel hub 5 up to the base 13 of the wheel hub 5.

The wheel is bearing-mounted around the wheel axle 15 by a bearing 18.

In mounted condition the bearing 18 is mounted in the wheel hub by a mounting ring 19 from synthetic material or the like which along its outer contour is provided with three protrusions 20 with which the mounting ring can be axially slid and secured in the aforementioned grooves 17.

Specific to the present disclosure is that the wheel 2 is provided with integrated lighting 3, in this case in the form of three LED lights 10 which are each mounted in the recess 11 of an aforementioned O-shaped spoke 9.

The recesses 11 in the lit spokes 9 can be covered by transparent or translucid covers 21, which for example are mounted on either side of the wheel 2 over the recesses on the spokes 9, for example by a snap-in system with snap-ins 22.

The aforementioned integrated electromagnetic power source 4 is incorporated in the wheel hub 5 and is for example composed of a stator 23 and a rotor 24.

In the case of the example the stator 23 is fixedly connected to the front fork 16 of the bicycle via the aforementioned wheel axle 15 which is non-rotatably locked in the front fork 16.

The stator 23 is for example provided with permanent magnets 25.

In the example, the rotor 24 is executed as a printed circuit board which is co-axially mounted around the stator 23 and is mounted non-rotatably in the wheel hub 5 between the base 13 of the wheel hub 5 and the mounting ring 19 with which the bearing 18 is mounted in the wheel hub 5.

The rotor 24 is provided, for example, with coils (not shown) which upon rotation of the rotor 24 around the stator 23 by rotating the wheel 2 around its axle 15 generate a voltage on the level of three contacts 26 with which the LED lights 10 are connected via the aforementioned grooves 17 in the casing 6 of the wheel hub 5. In the example the LED lights are oriented radially outwardly in a rigid way, mounted on the printed circuit board of the rotor 24 by the rigid contact pins 27 of the LEDs.

In mounted condition the LEDs 10 protrude outwardly through passages in the wheel hub 5, in this case through the grooves 17, from the wheel hub 5.

The operation is very simple and as follows.

When the bicycle 1 is ridden, the wheels 2 rotate around their wheel axle 15.

The rotor 24 hereby rotates in the wheel around the stator 23 on the wheel axle 15, such that a power is generated which lights up the LEDs 10 upon riding.

The aforementioned structure makes the assembly and disassembly of the integrated lighting 3 very simple in case of a loose wheel 2, such that replacement or repair is very simple. Indeed, after removing the bearing 18 thanks to the grooves 17 in the wheel hub 15, the printed circuit board, together with the LEDs 10 can be removed from and installed in the wheel hub in an axial direction.

It is understood that more or fewer LEDs 10 can be provided and also other types and at other places, for example in the form of a LED strip which is applied on the spokes or on a section thereof.

If relevant, the LEDs 10 can be coloured LEDs or LEDs that change or can change colour.

Optionally, the power source 4 can be provided with a rechargeable battery which is charged while riding, such that the lighting 3 continues to work briefly after stopping riding.

The number and the shape of the spokes 9 may also deviate from the aforementioned example.

The present disclosure is not necessarily limited to balance bicycles.

The present disclosure is not means limited to the embodiments described as an example and shown in the figures, but a wheel according to the present disclosure and a bicycle equipped therewith can be realised in all kinds of forms and dimensions without departing from the scope of the present disclosure.

1. A wheel for a bicycle, the wheel being provided with a hollow wheel hub with a bearing therein and one or more lit spokes with a recess and one or more LED lights which extend at least partially in the recess and provided with an integrated electromagnetic power source which provides power to the LED lights as soon as the wheel is driven when riding the bicycle, wherein the hollow wheel hub is formed by a casing with an open end and a base and the power source is applied between the base and the bearing, the casing of the wheel hub is provided with one or more grooves which extend from the open end of the wheel hub substantially in an axial direction and form a passage along which the LED lights are connected to the power source and that the bearing is mounted in the wheel hub by a mounting ring which along its outer contour is provided with one or more protrusions with which the mounting ring is configured to be axially slid and secured in the one or more aforementioned grooves and in that the recesses in the lit spokes are covered by a transparent or translucid cover on either side of the wheel.

2. The wheel according to claim 1, wherein the power source is composed of a stator and a rotor co-axially therewith, whereby in mounted condition the rotor is connected to the wheel hub in such a way that the rotor rotates with the wheel and the stator is freely rotatable relative to the rotor.

3. The wheel according to claim 2, wherein the rotor is provided with one or more contacts to which the LED lights are connected for their power supply.

4. The wheel according to claim 2, wherein the LED lights are mounted on the rotor radially outwardly.

5. The wheel according to claim 2, wherein the LED lights are rigidly connected with the rotor.

6. The wheel according to claim 1, wherein at least a part of the spokes are made as O-shaped or oval-shaped spokes which delimit an open recess in the spokes, whereby one or more LED lights extend at least partially up into the recess.

7. The wheel according to claim 6, wherein the recesses in the lit spokes with a LED light are covered by a transparent or translucid cover on either side of the wheel.

8. The wheel according to claim 1, wherein the wheel is provided with a rechargeable battery.

9. A bicycle provided with a wheel according to claim 1, wherein a wheel axle is non-rotatably mounted in a front fork or in a frame of the bicycle and around which the stator of the power source is non-rotatably mounted.

10. The bicycle according to claim 9, wherein the bicycle is a balance bicycle.

11. The wheel according to claim 3, wherein the LED lights are mounted on the rotor radially outwardly.

12. The wheel according to claim 3, wherein the LED lights are rigidly connected with the rotor.

13. The wheel according to claim 4, wherein the LED lights are rigidly connected with the rotor.

14. The wheel according to claim 2, wherein at least a part of the spokes are made as O-shaped or oval-shaped spokes which delimit an open recess in the spokes, whereby one or more LED lights extend at least partially up into the recess.

15. The wheel according to claim 3, wherein at least a part of the spokes are made as O-shaped or oval-shaped spokes which delimit an open recess in the spokes, whereby one or more LED lights extend at least partially up into the recess.

16. The wheel according to claim 4, wherein at least a part of the spokes are made as O-shaped or oval-shaped spokes which delimit an open recess in the spokes, whereby one or more LED lights extend at least partially up into the recess.

17. The wheel according to claim 5, wherein at least a part of the spokes are made as O-shaped or oval-shaped spokes which delimit an open recess in the spokes, whereby one or more LED lights extend at least partially up into the recess.

18. The wheel according to claim 11, wherein at least a part of the spokes are made as O-shaped or oval-shaped spokes which delimit an open recess in the spokes, whereby one or more LED lights extend at least partially up into the recess.

19. The wheel according to claim 12, wherein at least a part of the spokes are made as O-shaped or oval-shaped spokes which delimit an open recess in the spokes, whereby one or more LED lights extend at least partially up into the recess.

20. The wheel according to claim 13, wherein at least a part of the spokes are made as O-shaped or oval-shaped spokes which delimit an open recess in the spokes, whereby one or more LED lights extend at least partially up into the recess.
